(19) United States
(12) Patent Application Publication
(10) Pub. No.: US 2009/0071287 A1
(43) Pub. Date: Mar. 19, 2009

(54) EXTERNAL DIFFERENTIAL COVER FOR VEHICLES

(76) Inventor: Adam Paskowitz, YORBA LINDA, CA (US)

Correspondence Address: YING CHEN;Chen Yoshimura LLP, 255 S. GRAND AVE., # 215, LOS ANGELES, CA, 90012, US

(21) Appl. No.: 12/210,136

(22) Filed: Sep. 12, 2008

Related U.S. Application Data
(60) Provisional application No. 60/972,180, filed on Sep. 13, 2007.

(51) Int. Cl. F16H 57/02

(52) U.S. Cl. 74/606 R

(57) ABSTRACT

An external differential cover for a vehicle is described. The cover has a cup shape with magnets on the concave side, and can be magnetically attached to an existing differential cover of a vehicle without removing the latter. The external cover is preferably designed to fit over existing differential covers of various vehicle models. The external differential cover includes an artistic design on the exposed side. Lighting elements are provided and are connected to one or more light signals of the vehicle. The lighting elements preferably form a part of the artistic design and enhance the artistic effect of the design. Once mounted, the strong permanent magnets of the cover prevent it from being removed by the normal strength of a human. A demagnetizer element is provided to weaken the magnetic force and allow removal and adjustment of the cover. An anti-theft device is optionally provided.

This application claims priority from U.S. Provisional Patent Application No. 60/972,180, filed Sep. 13, 2007, pending, which is herein incorporated by reference in its entirety.

### BACKGROUND OF THE INVENTION

1. Field of the Invention

This invention relates to automotive accessories, and in particular, it relates to an external differential cover.

2. Description of the Related Art

A differential unit for a vehicle, positioned between the vehicle transmission and output axles to supply a driving force to the vehicle wheels, typically includes a differential housing that contain gearing and other mechanical parts and a differential cover attached to the housing to seal it. The differential is typically located in the rear or front of the vehicle and is readily visible on certain types of vehicles such as sport utility vehicles, light trucks, etc. Replacement differential covers are available commercially, some with artistic designs and some having deep capacities, but they require removing the existing differential cover (and draining the oil inside), and mounting the replacement cover using bolts.

### SUMMARY OF THE INVENTION

The present invention is directed to an external differential cover that can be attached to a vehicle's existing differential cover and is suitable for providing artistic displays.

A functional advantage of the present invention is that the external differential cover has magnets that help to improve the performance of differentials by removing unwanted ferrous particulates in the hypoid gear oil in the differentials.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides an external differential cover for covering an existing differential cover of a vehicle, which includes: a base having a concave side adapted for covering the existing differential cover and a convex side; a design element disposed on the convex side of the base; a plurality of magnets disposed on the concave side of the base; lighting elements disposed on or adjacent the design element; and wirings for electrically connecting the lighting elements to light signals of the vehicle.

The external differential cover may further include a de-magnetizing element made of a non-ferrous material and disposed on the concave side of the base, the de-magnetizing element having a thin, elongated shape and defining one or more cutouts, wherein the de-magnetizing element is moveable between a first position and a second position, wherein when the de-magnetizing element is in the first position, at least a first subset of the magnets are exposed though the cutouts and when the de-magnetizing element is in the second position, the first subset of the magnets are covered by the de-magnetizing element.

The external differential cover may further include an anti-theft device, which includes: a tab extending from the base with a bolt hole adapted to be aligned with a bolt hole of the existing differential cover; a headless bolt adapted for attaching the tab to the holt hold of the existing differential cover, the headless bolt having a socket with an irregular shape; and a key having a first end with a head and a second end with an irregular shape that fits into the irregular shaped socket of the headless bolt.

It is to be understood that both the foregoing general description and the following detailed description are exemplary and explanatory and are intended to provide further explanation of the invention as claimed.

### BRIEF DESCRIPTION OF THE DRAWINGS

FIGS. 1 and 2 are perspective views of an external differential cover according to an embodiment of the present invention.

FIG. 3 is a schematic cross-sectional view showing the external differential cover and the existing differential cover.

FIG. 4 is a plan view of an exemplary external cover designed to fit existing differential covers of many vehicle models.

FIG. 5 illustrates a mounting member for a magnet that uses a spring.

FIG. 6 illustrates a mounting member for a magnet that uses a universal joint.

FIG. 7 illustrates the antitheft device of the external differential cover.

FIGS. 8a and 8b illustrate an external differential cover having overreaching magnetic claws suitable for certain types of vehicles.

### DETAILED DESCRIPTION OF THE PREFERRED EMBODIMENTS

An external differential cover according to embodiments of the present invention is a cover that can be magnetically attached to an existing differential cover of a vehicle without removing the latter. It is referred to as an “external” differential cover because it does not serve the function of closing the differential housing and covering the mechanical parts inside the housing. The cover is preferably designed to fit the shape and size of existing differential covers of various vehicle models from the same or different manufactures. The external differential cover includes an artistic design on the exposed side of the cover, but the particular artistic designs are not a part of the invention. Lighting elements are optionally provided on the external differential cover and are connected to one or more light signals of the vehicle. The lighting elements preferably form a part of the artistic design and enhance the artistic effect of the design. Once mounted, the strong permanent magnets of the cover prevent it from being removed by the normal strength of a human. A demagnetizer element is optionally provided to weaken the magnetic force and allow removal and adjustment of the cover. In addition, an anti-theft device is optionally provided to prevent the cover from being removed by unauthorized persons.

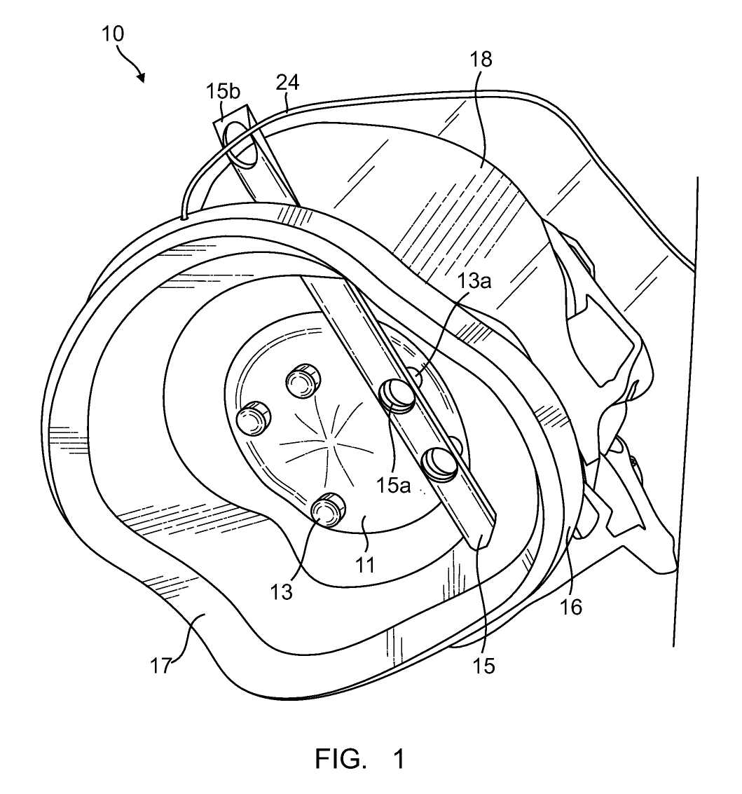

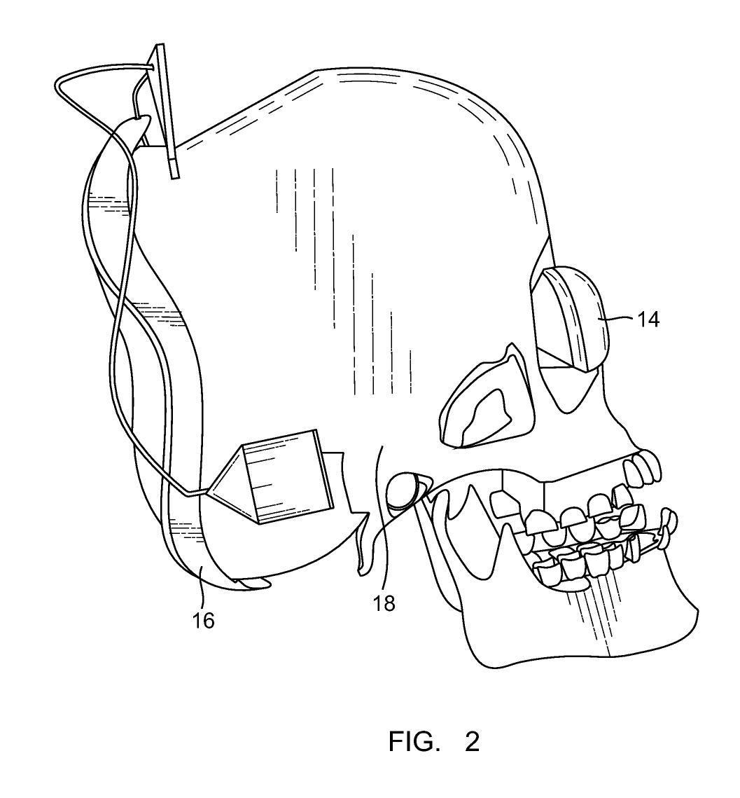

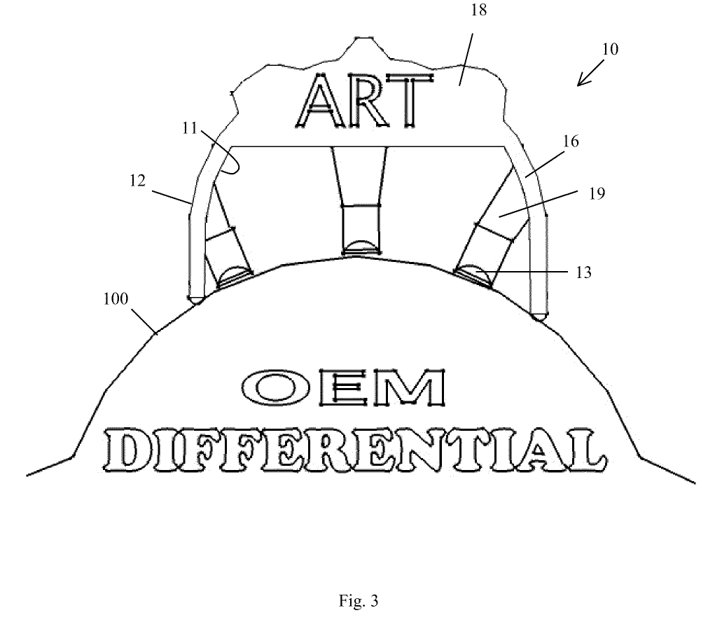

Existing differential covers of vehicles are typically shaped like a convex cup. As shown in FIGS. 1-3, the external differential cover 10 according to embodiments of the present invention has a cup-shaped base 16 with a concave first side 11 facing the existing differential cover 100 and a second side 12 on which an artistic design element 18 is formed or mounted. FIG. 1 is a perspective view taken from the first side of the cover 10 and FIG. 2 is a perspective view showing the artistic design element 18 mounted on the second side. FIG. 3 is a cross-sectional view schematically illustrating the relationship between the external cover 10 and the existing differential cover 100. The shape and size of the concave first side of the cover 10 are designed so that the cover fits over existing differential covers of many vehicles models. A number of permanent magnets 13 are located on the inside 11 of the cover 10 to securely attach the cover to the existing differential cover 100 which is made of ferrous metals. The permanent magnets 13 are preferably neodymium type magnets, but other types of permanent magnets may also be used. Each magnets 13 is mounted on the inside 11 of the cover by a mounting member 19. The positions (in three dimensions) of the magnets and the orientations of their surfaces facing the existing differential cover 100 are designed so as to create a strong magnetic field between the external cover 10 and the existing differential cover. The positions of the magnets 13 are designed so that the magnets either contact or are located close to the surface of the existing cover 100 with small air gaps. Suitable magnets 13 are used so that sufficiently strong magnet force exists between the external cover 10 and the existing cover 100 even when small air gaps exist between the magnets and the surface of the existing cover.

The shape and size of existing differential coders of different vehicle models are often different. The external cover 10 is preferably designed to fit over existing differential covers of a large number of vehicle models. The inventor has experimented with the placements of the magnets and discovered one or more magnet placements that were suitable for existing differential covers for a relatively large number of vehicle models, including vehicles manufactured by Ford Motor Company, General Motors, Toyota Motor Company, etc. In the experiments, a number of candidate magnet positions were defined inside the first side 11 of the cover. Then, for each of a number of vehicle models, it was empirically determined what combinations of candidate positions and corresponding magnet heights provided satisfactory magnetic force for attachment. The result for each vehicle models are combined and reconciled, and the placement was adjusted until a placement was found to work satisfactorily for a large number of vehicle models. In other words, the inventor has discovered at least one magnet placement that can be used to make a “one size fit all” external cover 10 for a large number of vehicle models.

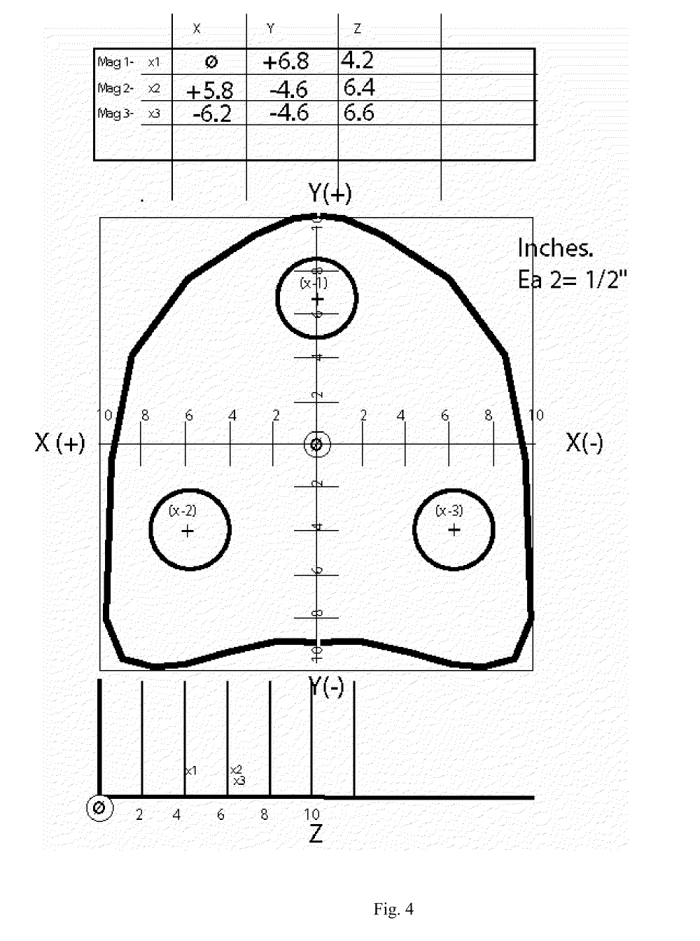

One particular example of a “one size fit all” external cover 10 obtained using the above approach is illustrated in FIG. 4. This example was. FIG. 4 is a schematic view from the rear of the external cover looking into the concave cover. Three magnets are provided at the following approximate positions (unit: inches):

magnet 1: x=0, y=+1.7, z=+1.05

magnet 2: x=+1.45, y=−1.15, z+1.6

magnet 3: x=−1.55, y=−1.15, z+1.65

The size of the cover is approximately 10 inches in the x direction and 10 inches in the y direction. The x and y coordinates given above are measured from an point located approximately at the center in both the x and y directions, as shown in FIG. 4. The z coordinates are measured from a plane through the rear-most points of the external cover.

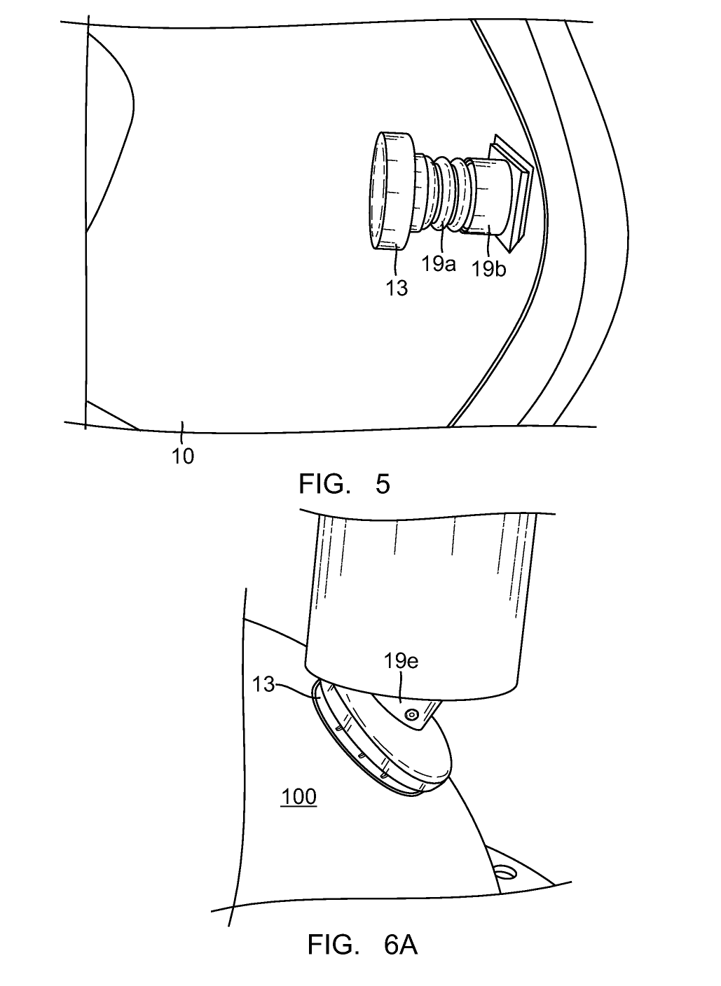

In one embodiment, the mounting members 19 are fixed rigid posts so that the magnets are fixed with respect to the cover 10. In another embodiment, the mounting members 19 for some or all of the magnets are resilient elements. Examples include springs, posts made of rubber or other resilient materials, etc. Using resilient mounting members allows the magnets 13 to self-adjust their positions to a certain extent, which tends to decrease or eliminate the gap between the magnets and the surface of the existing differential cover 100, thereby increasing the magnet force between the external cover 10 and the existing cover 100. In one particular example, shown in FIG. 5, a spring 19a is used, so that the distance by which the magnets 13 extends from the inside surface 11 of the external cover is self-adjustable. The magnet 13 may be urged by the spring 19a toward the surface of the existing differential cover 100, in which case the spring is compressed and will tend to push the external cover 10 away from the existing cover 100. Alternatively, the magnet 13 may be pulled to the surface of the existing cover 100 by magnetic force against the spring 19a, in which case the spring is extended and will tend to pull the external cover 10 toward the existing cover 100. Whether the spring 19a is compressed or extended will depend on the shape of the existing cover 100. Additionally, the spring 19a may bend to a certain extent to allow the magnet to shift laterally to reach a spot on the surface of the existing cover 100 that fits the magnet better. Further, the spring 19a may allow the surface of the magnet to change its orientation to a certain extent to allow the magnet to more fully contact the surface of the existing cover 100 instead of leaving a wedge-shaped gap. In another embodiment, the spring 19a is partially disposed inside a short, round tube 19b (see FIG. 5), or partially disposed around a short, rigid post (not shown). The tube or post reduces the lateral bending of the spring, but allows it to extend or compress. When a rubber post is used, the rubber post may bend to a certain extent to allow the magnet 13 to shift laterally. The resilient mounting members 19 should be sufficiently stiff so that the external cover 10 does not wobble significantly, but sufficiently flexible to allow certain amount of shift of the magnet mounted thereon.

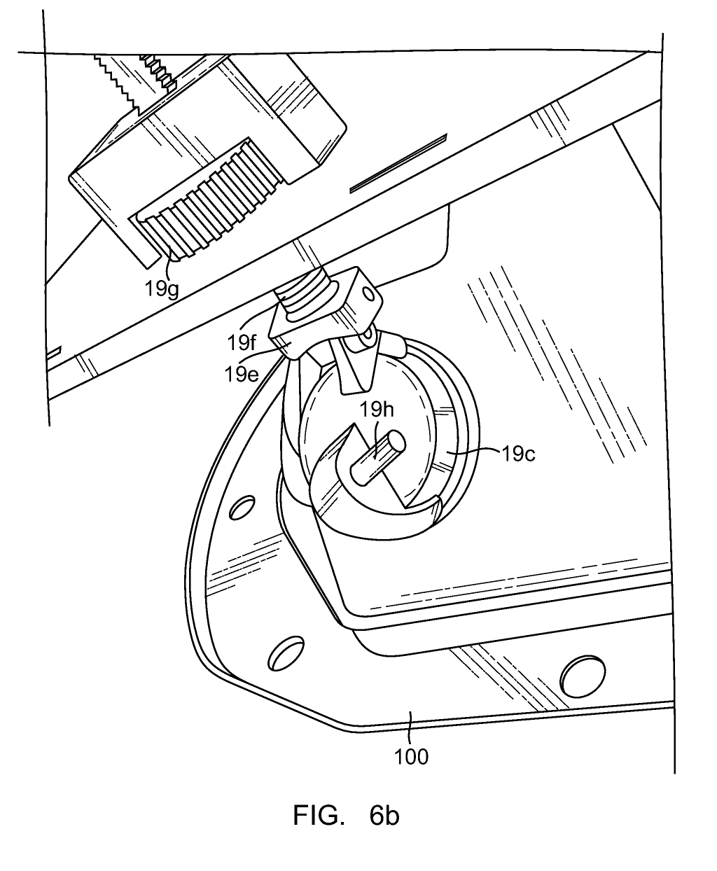

Another alternative mounting member for magnets, shown in FIGS. 6a and 6b, uses a universal joint 19e. The magnet 13 is attached to a rotating member of the universal joint. The universal joint 19e may use a ball-and-socket design, or two rotating axis, or any other suitable designs known in the art. The universal joint 19e is attached to the inside surface of the external cover 10 in a way that allows the magnet to extend away from or retract toward the inside surface of the external cover. In the example shown in FIG. 6b, the universal joint is connected to a screw-treaded shaft 19f and a small dialer 19g affixed to the external cover that allows fine adjustment of the distance between the magnet 13 and the inside surface of the external cover 10. (Note that FIG. 6b is a photograph of an experimental setup that illustrates the working principle of a universal joint. In the photograph, the dialer 19g affixed to a frame of the experimental setup rather than the external cover.) By using an extendable universal joint, the magnets can automatically adjust their positions and orientations to fit the surface shape of the existing differential cover 100 when mounted. As a result, the magnets 13 are more likely to come into actual contact with the surface of the existing differential cover 100. This tends to result in stronger magnetic force that attaches the external cover to the existing cover. Stronger magnetic force tends to prevent the external cover 10 from shifting or walking along the surface of the existing cover.

The universal joint shown in FIG. 6b additionally includes a small shaft 19h on the cup 19c that holds the magnet, which may be used in conjunction with a lever to lift the magnets when removing the external cover 10 from the existing cover 100.

To attach the external differential cover 10 to an existing differential cover 100, the user aligns the external cover to the existing cover, and then allows the magnetic force of the magnets 13 to pull the external cover toward the existing cover. Typically, the magnetic force is sufficiently strong to pull the external cover toward the existing cover and securely attach to it when the magnets 13 are within several inches from the existing cover 100. When installed, the magnets 13 will securely attach the cover 10 to the existing differential cover 100, and cannot be removed by the normal strength of an able bodied human being.

The external differential cover 10 also includes one or more lighting elements 14, such as light emitting diodes (LEDs). The lighting elements may be incorporated into the artistic design element 18. In the example illustrated in FIG. 2, the artistic design element 18 is a skull, and two red LEDs are located in the eyes of the skull. Electrical wires 24 (and circuits if desired, preferably housed inside the artistic design element 18) are provided for electrically connecting the lighting elements to various light signals and power supply of the vehicle. This may be done by using available wiring harness or wires on the vehicle, such as trailer towing wiring provided for the purpose of transmitting light signals to a trailer pulled by the vehicle. In the above example, the two red LEDs 14 may be connected to the brake light signal of the vehicle, so the eyes of skull will light up when the brake pedal is depressed. In another example, two amber LEDs are provided in addition to the two red LEDs and are connected to an electrical signal that turns on when the headlights are on. Electronic circuitry may be provided in the cover 10 to generate various signal or signal combinations for the lighting elements using the vehicle's own lighting signal as an input. The lights may also be controlled by various conditions of the vehicle, such as a motion sensor. The various lights of the various lights of the external cover may also be powered by an external battery provided in the external cover.

In manufacturing, the cup-shaped base 16 of the cover 10 and the artistic design element 18 may be formed as two separate pieces joined together. The base 16 is preferably made of, or primarily made of, plastic materials including but not limited to polycarbonate, ABS (acrylonitrile butadiene styrene), PMMA (Polymethyl methacrylate), PVC (Polyvinyl chloride), vinyl additives, etc., or fibre-reinforced plastic materials, or any other suitable materials. Preferred materials are strong and lightweight materials. The artistic design element 18 may be made of any suitable material, such as plastic, metal, etc. The parts of the cover 10 may be formed by injection molding. The base 16 and the artistic design element 18 are preferably joined together by snaps. Alternatively, they may be joined together by adhesives or other fastening means. The surface of the cover 10 may be coated with a clear coating, paint or vacuum metalizing (which creates the appearance of being chromed). The coating is preferably water and dirt/dust resistant.

As described earlier, the magnetic force between the external cover 10 and the existing differential cover 100 is sufficiently strong to prevent the cover 10 from being removed by the normal force of a human. An optional demagnetizing element 15 is provided to allow the external cover 10 to be removed or adjusted. As shown in FIG. 1, the demagnetizing element 15 is a thin, elongated bar or plate made of a non-ferrous material such as a plastic and has one or more cutouts 15a. The demagnetizing element 15, preferably slightly bent to fit the curved shape of the existing differential cover 100, is inserted from a slit on the cover 10 into the inside of the cover adjacent the existing differential cover 100. A part 15b of the demagnetizing element is exposed outside of the cover 10. A guide structure (not shown) may be provided inside the cover 10 adjacent the demagnetizing element 15 to keep it in place. The demagnetizing element 15 may be made of a flexible material to facilitate its movement along the guide structure. One or more magnets 13a are located such that they are aligned with the one or more cutouts 15a of the demagnetizing element 15 when the latter is in a normal, installed position. These magnets 13a are also sized such that a gap exist between them and the surface of the existing cover 100 to allow the demagnetizing element 15 to be inserted or moved. When the demagnetizing element 15 is in the normal position (as shown in FIG. 1), the gaps between the magnets 13a and the surface of the existing differential cover 100 are filled with air, and the magnets exerts a strong magnetic force which form a part of the total magnetic force that attaches the external cover 10 to the existing cover 100.

To remove the external cover 10 from the existing cover 100, the demagnetizing element 15 is moved to a second position, for example by pulling it upwards, such that the cutouts 15a are no longer aligned with the magnets 13a. As a result, a non-ferrous material (the demagnetizing element 15) now exists in the gaps between the magnets 13a and the surface of the existing cover 100, significantly weakening the magnetic force between them. As the total magnetic force between the external cover 10 and the existing cover 100 is reduced, the cover 10 can now be separated from the existing cover 100 using the normal strength of a human. The demagnetizing element 15 may also be used when installing the external cover 10. For example, the demagnetizing element 15 may be located in its second position when the user aligns the external cover 10 with the existing cover 100. After the external cover 10 is attached to the existing cover 100 and its position adjusted if necessary, the demagnetizing element 15 is moved (e.g. pushed down) to it normal position to secure the cover 10. The shape and structure of the demagnetizing element 15 can be different from those shown in FIG. 1, so long as it has a thin plate that can be moved between a first position where it is interposed between a magnet and the existing differential cover and a second position where it is not interposed because the magnet and the existing cover.

The demagnetizing element 15 is optional. Alternatively, a simpler tool in the form of a bar with a hook at one end may be provided to provide a mechanical advantage to remove the external cover 10. The hook may be inserted between the rim of the external cover 10 and the existing cover 100 and a force is applied at the other end of the bar to force the external cover off.

Further, the magnets 13 may be electromagnets if electricity is available.

A rubber seal 17 is optionally provided along the rim of the based 16 of the external cover 10 where the cover is adjacent to or in contact with the existing differential cover 100, as shown in FIG. 1.

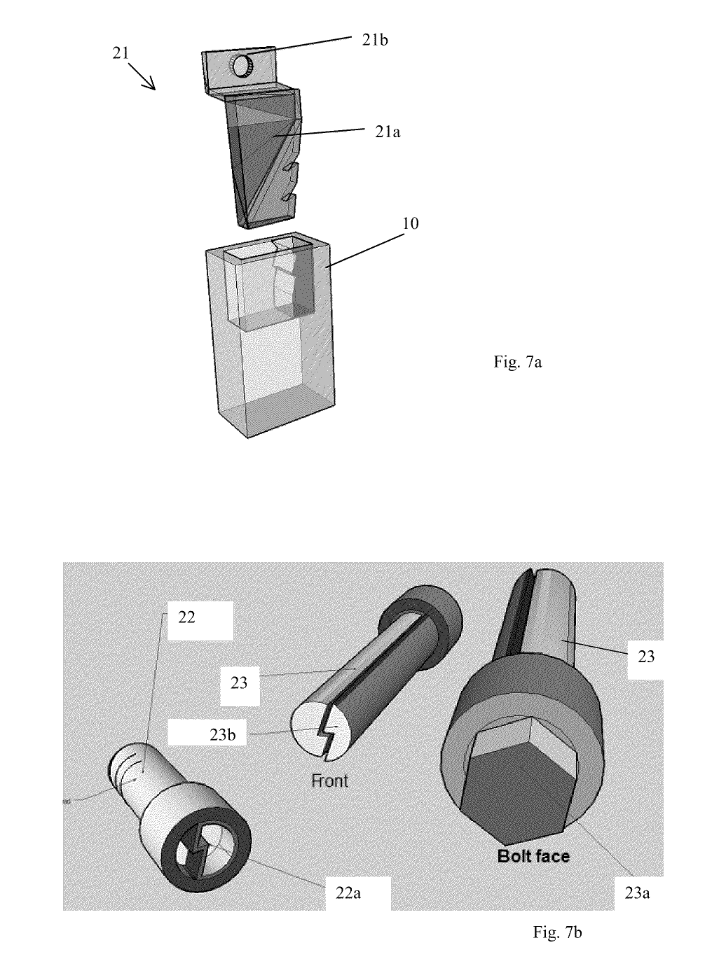

FIGS. 7a and 7b show an anti-theft device 21 optionally provided for the external differential cover 10. A tab 21a (such as a one-way snap-in tab that is inserted into a female receiving slot 10a on the cover 10) with a bolt hole 21b is provided on the cover 10. The bolt hole is positioned to align with a bolt (such as the top-most bolt) on the existing cover 100 when the cover 10 is properly installed. The corresponding bolt on the existing cover 100 is removed and replaced with a headless bolt 22 that attaches the tab 21a (and therefore the cover 10) to the existing cover 100. The headless bolt 22 requires a specially designed key 23 to unscrew. The key 23 has one end 23a with a regular head that fits a regular screwdriver or wrench, and another end 23b with an irregular shape that fits into an irregular-shaped socket 22a in the headless bolt 22. In the example shown in FIGS. 7a and 7b, the key 23 and the headless bolt 22 have a “lightning” shape.

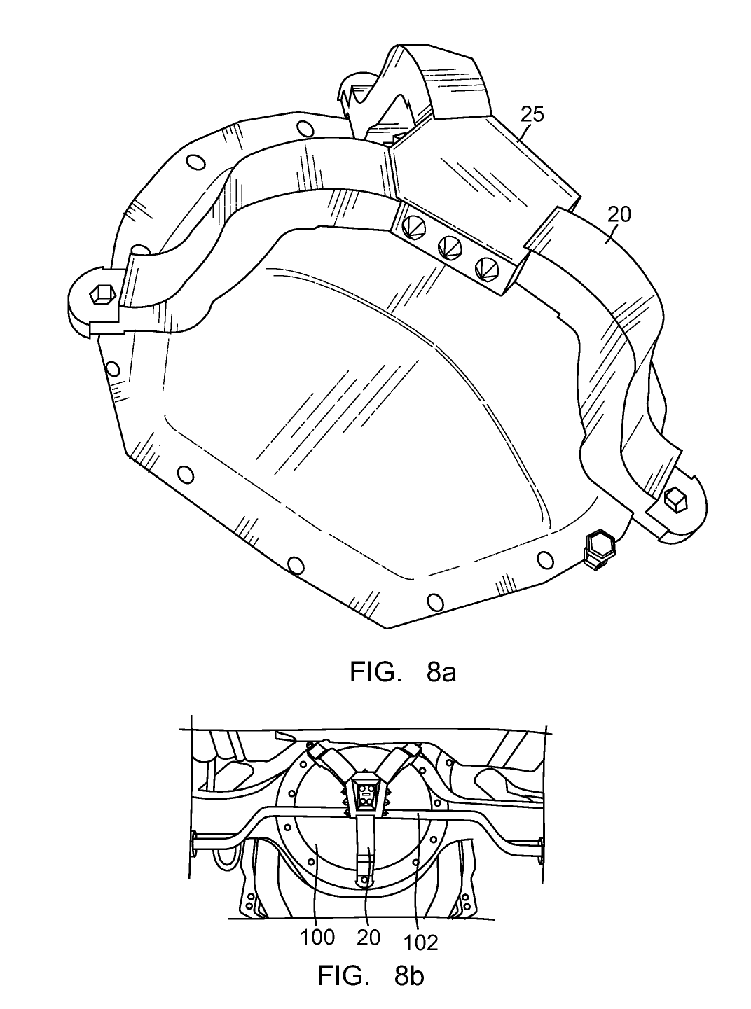

Special designs for the external differential cover 10 may be provided for certain vehicle models that have special features. For example, the Hummer model vehicles made by General Motors use the GM 12 bolt differential and a rear facing sway bar which blocks the user's ability to attach the external cover 10 shown in FIGS. 1 and 2. An external differential cover 20 with an overreaching magnetic claw 25, as shown in FIGS. 8a and 8b, is designed to allow the sway bar 102 to run between the external cover 20 and the existing differential cover. The cover 20 is attached to the existing cover 100 by bolts.

An additional advantage of the external differential cover 10 is that the magnets 13 help to improve the performance of differentials by removing unwanted ferrous particulates that are found in the hypoid gear oil in the differentials. A differential, especially during the break-in period, produces metal shavings that are the result of a metal-on-metal wear between the ring gear and the pinion gear. The presence of these ferrous particulates causes excessive wear and reduces the life of the differential. The ring and pinion gears are set very specifically and require a critical and exacting endplay or backlash. The particulates negatively affect the endplay. Automotive manufacturers attempt to solve this problem by placing a small magnet in the oil pan of each differential to pull shearing metal particulates away from the sensitive and uniquely aligned parts. However, these small magnets are sometimes not adequate for dealing with the amount of ferrous particulates in the oil. When an external differential cover 10 is used, the magnets 13 create a strong magnetic field that will pull substantially all particulates in the differential away from the critical parts. This helps to extend the life and enhance the reliability of the differential.

It will be apparent to those skilled in the art that various modification and variations can be made in the external differential cover the present invention without departing from the spirit or scope of the invention. Thus, it is intended that the present invention cover modifications and variations that come within the scope of the appended claims and their equivalents.

What is claimed is:

1. An external differential cover for covering an existing differential cover of a vehicle, comprising:
a base having a concave side adapted for covering a portion of the existing differential cover and a convex side; and
a plurality of magnets disposed on the concave side of the base for mounting the external differential cover to the existing differential cover.

2. The external differential cover of claim 1, further comprising:
a plurality of rigid mounting elements for mounting the magnets on the concave side of the base.

3. The external differential cover of claim 1, further comprising:
a plurality of resilient mounting elements for mounting the magnets on the concave side of the base.

4. The external differential cover of claim 1, wherein each resilient mounting member includes a spring.

5. The external differential cover of claim 1, wherein each resilient mounting member includes a rubber post.

6. The external differential cover of claim 1, further comprising:
a design element disposed on the convex side of the base.

7. The external differential cover of claim 2, further comprising:
lighting elements disposed on or adjacent the design element; and
wirings for electrically connecting the lighting elements to light signals of the vehicle.

8. The external differential cover of claim 1, further comprising a de-magnetizing element made of a non-ferrous material and disposed on the concave side of the base, the de-magnetizing element being a thin plate and defining one or more cutouts,
wherein the de-magnetizing element is moveable between a first position and a second position, wherein when the de-magnetizing element is in the first position, at least a first subset of the magnets are exposed though the cutouts and when the de-magnetizing element is in the second position, the first subset of the magnets are covered by the de-magnetizing element.

9. The external differential cover of claim 1, further comprising an anti-theft device, which comprises:
a tab extending from the base with a bolt hole adapted to be aligned with a bolt hole of the existing differential cover;
a headless bolt adapted for attaching the tab to the holt hold of the existing differential cover, the headless bolt having a socket with an irregular shape; and
a key having a first end with a head and a second end with an irregular shape that fits into the irregular shaped socket of the headless bolt.
